(19) United States
(12) Patent Application Publication
(10) Pub. No.: US 2026/0187812 A1
(43) Pub. Date: Jul. 2, 2026

(54) METHOD AND SYSTEM FOR SEGMENTING FACES OF COMPONENT(S) IN STEREOLITHOGRAPHY (STL) FILES

(71) Applicant: HCL Technologies Limited, New Delhi (IN)

(72) Inventors: Tathagata C, Pune (IN); Manoj B, Pune (IN); Abhijit K, Pune (IN); Nitin U, Pune (IN)

(21) Appl. No.: 19/287,856

(22) Filed: Aug. 1, 2025

(30) Foreign Application Priority Data
Jan. 2, 2025 (IN) 202511000570

(51) Int. Cl. G06T 7/12; G06T 7/181

(52) U.S. Cl. CPC G06T 7/12; G06T 7/181; G06T 2200/24; G06T 2207/20081; G06T 2207/20104

(57) ABSTRACT

This disclosure relates to a method and system for segmenting faces of component in STL files. The method may include detecting by a controller an expanding and contiguous set of triangles based on an order of occurrence thereof in the STL file. Further, the method may include identifying by the controller a plurality of hard edges and a plurality of hard co-edges of each triangle from the expanding and contiguous set of triangles. Further, the method may include determining by the controller a closed loop formed by collating the plurality of hard edges and the plurality of hard co-edges. Further, the closed loop may form a boundary corresponding to a face. Further, the method may include segmenting by the controller at least one face by identifying at least one boundaries corresponding to the face based on the determining the closed loop.

### TECHNICAL FIELD

This disclosure generally relates to face segmentation, and more particularly to the method and system for segmenting the faces of components in Stereolithography (STL) files.

### BACKGROUND

Stereolithography (STL) files are widely used formats in 3D modeling and printing to facilitate the exchange of 3D data between software applications and the manufacturing processes. STL files are utilized in CAD (Computer Aided Design), CAM (Computer Aided Manufacturing), and CAE (Computer Aided Engineering) software applications and products to enable designers to share and collaborate on 3D models.

When recovering or restoring parametric information of components from reverse engineering STL files, such reverse engineering remains difficult to automate or requires prohibitive amounts of manual effort. For example, in downstream applications, each face of the component must be segmented in the STL file and must be defined before manufacturing the said component. However, in STL files, each facet may include a bunch of triangles, and hence, to define a face, the engineer manually selects the one or more triangles from the bunch of triangles to segment the face from the facet. Based on the segmentation of the face, a toolpath may be generated to manufacture the component.

However, while selecting the one or more triangles, a scenario may occur in which a few triangles may be missed by the engineer, or the engineer may inadvertently include additional triangles. Such selection may add additional features to the component, and hence, the resultant toolpath may be incorrect. Such methods may also increase the growth and clustering of the segmentation, and hence, the segmentation of the face may not be robust.

Therefore, there is a requirement for an efficient and effective method and system for segmenting faces of components in STL files.

### SUMMARY OF THE INVENTION

In an embodiment, a method for segmenting at least one face of a component in a Stereolithography (STL) file is disclosed. The method may include detecting by a controller an expanding and contiguous set of triangles based on an order of occurrence thereof in the STL file. Further, the method may include identifying by the controller a plurality of hard edges and a plurality of hard edges, and a plurality of hard co-edges of each triangle from the expanding and continuous set of triangles. Further, the method may include determining by the controller a closed loop formed by collating the plurality of hard edges and the plurality of hard co-edges. Further, the close loop may form a boundary corresponding to a face. Further, the method may include segmenting by the controller of at least one face by identifying at least one boundary corresponding to the face based on the determining the closed loop.

In an embodiment, a method for visual inspection and correction of a segmented face of a component in a stereolithography (STL) file is disclosed. The method may include determining by the controller a reference triangle based on manual input from a user via a selection tool embedded in a user interface accessible to the user through a user device. The method may include determining by the controller a face of the component by selecting one or more successive triangles occurring contiguously in a neighborhood of the reference triangle in an order of occurrence of an expanding and contiguous set of triangles in the STL file. The one or more successive triangle may be selected based on a range of selection manipulated by the user using the selection tool.

In an embodiment, a system for segmenting at least one face of a component in a stereolithography (STL) file. The system may include a processor, and a memory communicably coupled to the processor. The memory may store the processor-executable instructions which when executed by the processor, cause the processor to detect an expanding and contiguous set of triangles based on an order of occurrence thereof in the STL file. Further, the processor-executable instructions, on execution, may further cause the processor to identify a plurality of hard edges and a plurality of hard co-edges of each triangle from the expanding and contiguous set of triangles. Further, the processor-executable instructions, on execution, may further cause the processor to determine a closed loop formed by collating the plurality of hard edges and the plurality of hard edges, the closed loop may form a boundary corresponding to a face. Further, the processor-executable instructions, on execution, may further cause the processor to segment at least one face by identifying at least one boundaries based on the determination of the closed loop.

In an embodiment, a system for visual inspection and correction of a selection of a segmented face of a component in a Stereolithography (STL) file. The system may include a user device, a processor, and a memory communicably coupled to the processor. The memory may store processor-executable instructions when executed by the processor, causing the processor to determine a reference triangle based on manual input from a user via a selection tool embedded in a user interface accessible to the user through the user device. Further, the processor-executable instructions, on execution, may cause the processor to determine the face of the component by selecting one or more successive triangles occurring contiguously in a neighborhood of the reference triangle in an order of occurrence of an expanding and contiguous set of triangles in the STL file. The one or more successive triangles may be selected based on a range of selection manipulated by the user using the selection tool.

In an embodiment, a non-transitory computer-readable medium storing computer-readable instructions for segmenting faces of component in STL files is disclosed. In one example, the stored instructions, when executed by a processor, may cause the processor to perform operations including detecting, an expanding and contiguous set of triangles based on an order of occurrence thereof in the STL file. The operation may further include identifying a plurality of hard edges and a plurality of hard co-edges of each triangle from the expanding and contiguous set of triangles. The operation may further include determining a closed loop formed by collating the plurality of hard edges and the plurality of hard co-edges. Further, the closed loop may form a boundary corresponding to a face. The operation may further include segmenting at least one face by identifying at least one boundary corresponding to the face based on determining the closed loop.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 illustrates a block diagram of an exemplary system for segmenting faces of components in STL files, in accordance with an embodiment of the present disclosure.

FIG. 2 illustrates a functional block diagram of various modules within the memory of an electronic device configured to segment faces of components in STL files, in accordance with an exemplary embodiment of the present disclosure.

FIG. 3 illustrates a perspective view of a component in the STL file, in accordance with an embodiment of the present disclosure.

FIG. 4 illustrates a perspective view of another component in the STL file, in accordance with an exemplary embodiment of the present disclosure.

FIG. 5 illustrates a perspective view of another component in the STL file, in accordance with an exemplary embodiment of the present disclosure.

FIG. 6 illustrates a flowchart of a method for segmenting faces in STL files, in accordance with an exemplary embodiment of the present disclosure.

FIG. 7 illustrates a flowchart of a method for visual inspection and correction of a segmented face of a component in a Stereolithography (STL) file, in accordance with an exemplary embodiment of the present disclosure.

### DETAILED DESCRIPTION OF THE DRAWINGS

The foregoing description has broadly outlined the features and technical advantages of the present disclosure in order that the detailed description of the disclosure that follows may be better understood. Additional features and advantages of the disclosure will be described hereinafter which forms the subject of the claims of the disclosure. It should be appreciated by those skilled in the art that the conception and specific embodiments disclosed may be readily utilized as a basis for modifying other devices, systems, assemblies, and mechanisms for carrying out the same purposes of the present disclosure. It should also be realized by those skilled in the art that such equivalent constructions do not depart from the scope of the disclosure as set forth in the appended claims. The novel features which are believed to be characteristics of the disclosure, to its device or system, together with further objects and advantages will be better understood from the following description when considered in connection with the accompanying figures. It is to be expressly understood, however, that each of the figures is provided for the purpose of illustration and description only and is not intended as a definition of the limits of the present disclosure.

The terms “including”, “comprises”, “comprising”, or any other variations thereof, are intended to cover a non-exclusive inclusion, such that a system or a device that comprises a list of components or steps does not include only those components or steps but may include other components or steps not expressly listed or inherent to such setup or device. In other words, one or more elements in a system or apparatus proceeded by “comprises . . . a” does not, without more constraints, preclude the existence of other elements or additional elements in the system or apparatus.

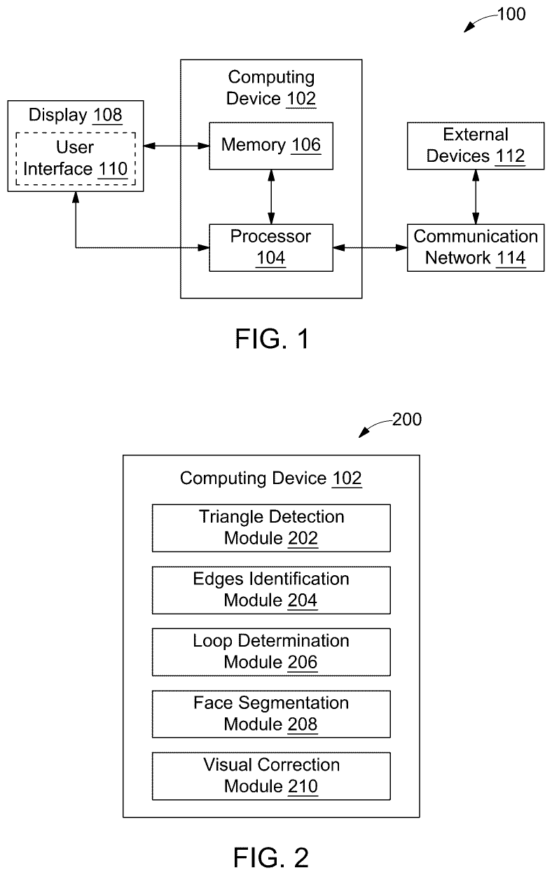

Reference will now be made to the exemplary embodiments of the disclosure, as illustrated in the accompanying drawings. Wherever possible, same numerals have been used to refer to the same or like parts. The following paragraphs describe the present disclosure with reference to FIGS. 1-6.

Referring now to FIG. 1, an exemplary system 100 for segmenting faces of components in STL files, in accordance with some embodiments of the present disclosure. The system 100 may include a computing device 102 (for example, server, desktop, laptop, notebook, netbook, tablet, smartphone, mobile phone, or any other computing device). The computing device 102 herein may be interchangeably referred to as controller 102.

As will be described in greater detail in conjunction with FIGS. 2-6, the computing device 102 may detect an expanding and contiguous set of triangles based on an order of occurrence thereof in the STL file. The computing device 102 may identify a plurality of hard edges and a plurality of hard co-edges of each triangle from the expanding and contiguous set of triangles. Further, the computing device 102 may determine a closed loop formed by collating the plurality of hard edges and plurality of hard co-edges of each triangle from the expanding and contiguous set of triangles from the expanding and contiguous set of triangles. Further, the computing device 102 may segment at least one face by identifying at least one boundaries corresponding to the face based on the determining the closed loop.

In some embodiments, the computing device 102 may include one or more processors 104 and a memory 106. Further, the memory 106 may store instructions that, when executed by the one or more processors 104, cause the one or more processors 104 to segment one or more faces of the component in the STL file. The memory 106 may also store various data (for example, a dashboard canvas, a set of widgets, a metadata for each of the set of widgets associated with a user account of the user, and the like) that may be captured, processed, and/or required by the system 100. The memory 106 may be a non-volatile memory (e.g., flash memory, Read Only Memory (ROM), Programmable ROM (PROM), Erasable PROM (EPROM), Electrically EPROM (EEPROM) memory, etc.) or a volatile memory (e.g., Dynamic Random Access Memory (DRAM), Static Random-Access memory (SRAM), etc.).

The system 100 may further include a display 108. The system 100 may interact with a user via a user interface 110 accessible via the display 108. The system 100 may also include one or more external devices 112. In some embodiments, the computing device 102 may interact with the one or more external devices 112 over a communication network 114 for sending or receiving various data. The external devices 112 may include, but may not be limited to, a remote server, a digital device, or another computing system.

Referring now to FIG. 2, a functional block diagram 200 of various modules within the memory of an computing device 102 configured to segment faces of components in STL files, in accordance with some exemplary embodiment of the present disclosure. The system 200 may include a triangle detection module 202, an edge identification module 204, a loop determination module 206, a face segmentation module 208, and a visual correction module 210.

The triangle detection module 202 may be configured to detect one or more triangles of the component in the STL file. For example, as explained earlier, each facet of the component in the STL file may include one or more triangles. The one or more triangles may occur contiguously and in an expanding manner within the component, i.e., the quantity of triangles, and sizes thereof, may increase across various facets. Further, the quantity of triangles may be analyzed to determine one or more hard edges, or hard co-edges, using the edge identification module 204.

The edge identification module 204 may be used for the identification of hard edges, or hard co-edges of the one or more triangles of the component. The hard edges and hard co-edges herein imply, an edge, and a co-edge shared by various triangles of a facet with triangles of an adjacent facet. Moreover, the edge identification module 204 may be configured to determine the hard edges and hard co-edges based on a predefined rule. The predefined rule may include an edge angle bout the hard edge and the hard co-edge exceeding a predefined angle. The edge angle herein may be referred to an angle subtended at the edge by one or more facets. For example, if two facets sharing a common edge may subtend an angle on the said edge greater than 45°, then the common edge may be determined as a hard edge, or a hard co-edge. The edge identification module 204 may iteratively apply the predefined rule until all hard edges, and hard co-edges may be identified within the component. Alternatively, the edge identification module 204 may utilize machine learning models, such as but not limited to Decision Trees/Random Forests, Support Vector Machines (SVM), Neural Networks, and the like, to determine the hard edges, or hard co-edges of the component.

Based on the hard edge and the hard co-edge determined, the loop determination module 206 may detect any loops formed by collating the hard edge and the hard co-edge. For example, the loop determination module 206 may be configured to collate the plurality of hard edge and hard co-edges. If the collated hard edges and the hard co-edges form a loop or a closed surface area, a loop of the facet may be determined. In case the loop may not be formed by collating the plurality of hard edge and hard co-edges, it must be noted that the method may be re-iterated to detect additional triangles. For example, the triangle detection module 202 may detect one or more neighboring triangle from the set of contiguous and expanding triangles, using which the edge identification module 204 may further determine additional hard edges and hard co-edges. Accordingly, the additional hard edges and hard co-edges may be collated along with the already-collated hard edges and hard co-edges until a closed loop may be determined.

Based on the closed loop determined, the face segmentation module 208 may be configured to mark the closed loops as a boundary. Further, the face segmentation module 208 may be configured to determine the facet enclosed by the boundary. Accordingly, the facet within the boundary may be marked, and segmented as a face.

Moreover, the triangle detection module 202, the edge identification module 204, the loop determination module 206, and the face segmentation module 208 may be configured to iterate the process explained above, to segment all faces of the component in the STL file. It must be noted that in case of unsegmented facets between segmented faces of the component may also be segmented as a face by the face segmentation module 208.

With appropriate detection of boundary associated with the segmented face by the face segmentation module 208, the majority of the faces of the component in the STL file may be detected. However, facets sharing no hard edge, or hard co-edge therebetween, may be segmented in a single face. For example, one or more facets may include a chamfered portion or a trimmed portion therebetween may be accounted as a single face. Such scenarios may result in inaccurate segmentation of faces.

Therefore, the visual correction module 210 may enable variation of the range of selection of the face, or in other words, range of the boundary. Further, the range of selection of the boundary, or the face, may be displayed to a user through the user interface 110 of the display 108.

The user interface 110 may include a visual correction tool, which may be utilized by the user to modify, i.e., increase, or decrease the range of selection of the boundary on the component. To increase or decrease the range of selection, the user may select a reference triangle within the boundary. Further, the user may be configured to select a neighboring triangle (neighboring to the reference triangle) from the set of contiguous and expanding triangles. Such selection may increase the range of the boundary on the component. The modification by the user using the visual correction tool may be received by the visual correction module 210 as user input. Accordingly, based on the user input, the visual correction module 210 may be configured to modify the range of selection of the boundary, such that the boundary on a facet may not overlap another facet. Hence, the face of the component may be accurately segmented.

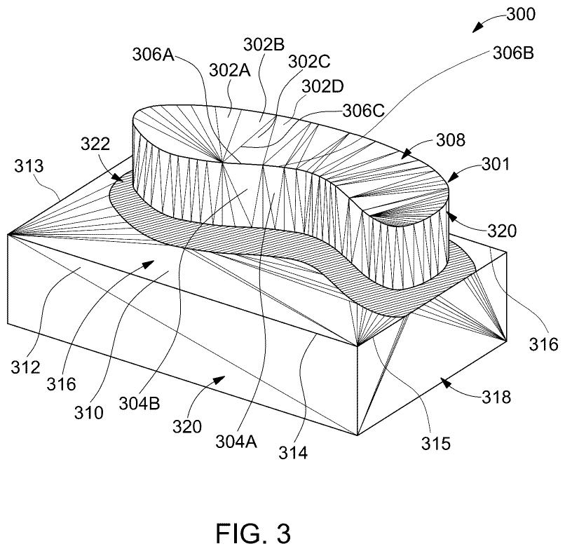

Now, FIG. 3 illustrates a perspective view 300 of a component 301 in the STL file, in accordance with an embodiment of the present disclosure. The STL file herein may include a non-parametric STL file. The components may include one or more facets 308, 310, 312, 314, 316, 318, 320 and 322. It must be noted that the facets herein may include undetected facets which are not segmented into faces.

To segment one or more face in the component 301, the computing device 102, with the triangle detection module 202 may be configured to determine one or more triangles within the component 301. For example, the computing device 102, with the triangle detection module 202 may be configured to detect one or more triangles, which may include, but not limited to triangles 302A, 302B, 302C, 302D in the facet 308, and triangles 310, and 312 in the facet 316. within the component 301. It must be noted that the triangles 302A, 302B, 302C, 310, and 312 within the component 301 may be for illustrative purposes only, and may include more triangles based on the total facets, or features of the component 301.

Further, based on the triangles 302A, 302B, 302C, 302D, 310, and 312 detected, the computing device 102, with the edge detection module 204, may be configured to determine the hard edges or the hard co-edges. For example, referring to FIG. 3, as edge 306A may be shared by triangles 302C and 304B, and edge 306C may be shared by triangles 302B and 302C respectively. The edge 306C herein may be referred to as the hard co-edge. Moreover, the triangle 302C may belong to facet 308, and the triangle 304B may belong to the facet 320. Further, the computing device 102 with the edge detection module 204 may be configured to determine an angle subtended about the edge 306A by the facet 308 and the facet 320. As the angle exceeds a predefined threshold, the edge 306A may be determined as a hard edge. It must be noted that the edges 306A, and 306B, within the component 301 may be for illustrative purposes only, and may include more edges based on the total facets, or features of the component 301.

Similarly, for triangles 310 and 312, which belong to facets 316 and 320 respectively, the computing device 102 may be configured to determine an edge angle between the facets 316 and 320 about the common edge 314. Accordingly, the computing device 102 may be configured to determine the common edge 314 as a hard edge, when the edge angle between the facets 316 and 320 exceeds the predefined threshold. Hence, the computing device 102 with the edge detection module 204, in a similar manner, may be configured to determine one or more hard edges and hard co-edges throughout the component 301.

Further, with the hard edges determined, the computing device 102 with the loop determination module 206, may be configured to collate the hard edges to determine a loop. For example, referring to FIG. 3, the computing device 102 with the loop determination module 206 may be configured to collate hard edges (for example, hard edge 306A and 306B) to determine a loop, which may enclose the facet 308. In another example, the computing device 102 may be configured to collate hard edges 313, 314, 315, and 316, which may form a loop enclosing the facet 316. Accordingly, one or more loops may be identified by the computing device 102 with the loop determination module 206.

With the loop determined, the computing device 102 with the face segmentation module 208, may identify, or mark the one or more loops as the boundary. Accordingly, the facets enclosed by the loop, which may be marked as a boundary, may be segmented as a face. Accordingly, the one or more facets 308, 310, 312, 314, 316, 318, and 320 enclosed by boundaries may be identified, and segmented as faces of the component 301. As no hard edges may de determined for the facet 322, by virtue of the position of the facet between facet 316 and facet 320, the facet 322 may also be segmented into the face.

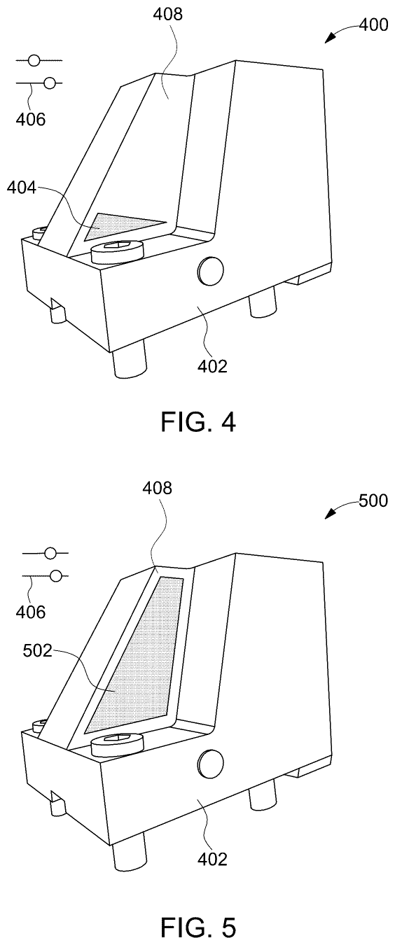

Now, FIG. 4 illustrates a perspective view 400 of a component 402 in the STL file, and FIG. 5 illustrates another perspective view 500 of a component 402 in the STL file. As explained earlier, components in which one or more facets are interconnected by a chamfered portion or a trimmed portion may be accounted as a single face, as a boundary related to one facet may overlap the adjacent facet. Such scenarios may result in inaccurate segmentation of the faces of the component.

Therefore, to prevent the boundaries from overlapping over one or more facets, the user may manually modify the boundaries identified by the computing device 102. The boundary may be represented as a range of selection 404 of the triangles on the component 402 by the user interface 110, on a display 108. Moreover, the range of selection may be modified by a selection tool 406 embedded in the user interface 110. For example, referring to FIG. 4, the boundary determined by the user may be modified, i.e. increased or decreased by operating the selection tool 406. The operation of the selection tool 406 may be received by the computing device 102 as the user input.

For example, in FIG. 4, the user may consider an initial range of selection 404 within the component 402, and may operate the selection tool 406 to increase the range of selection to enclose a facet 408 of the component 402. The user may select a reference triangle in the initial range of selection 404, and may operate the selection tool 406 to select a neighboring, or a successive triangle to the reference triangle. Accordingly, this operation of the selection tool 406 may exhibit an increase in range of selection. Such operation of the selection tool 404 may be received as the user input by the computing device 102, and using the visual correction module, the initial range of selection 404 may be increased to a final range of selection 504 illustrated in FIG. 5. Accordingly, the facet 408 may be properly segmented into the face.

It must be noted that the component 402 illustrated by FIGS. 4-5 are exemplary, and similar method to manually correct the boundary may also be implemented in the component 301 of FIG. 3.

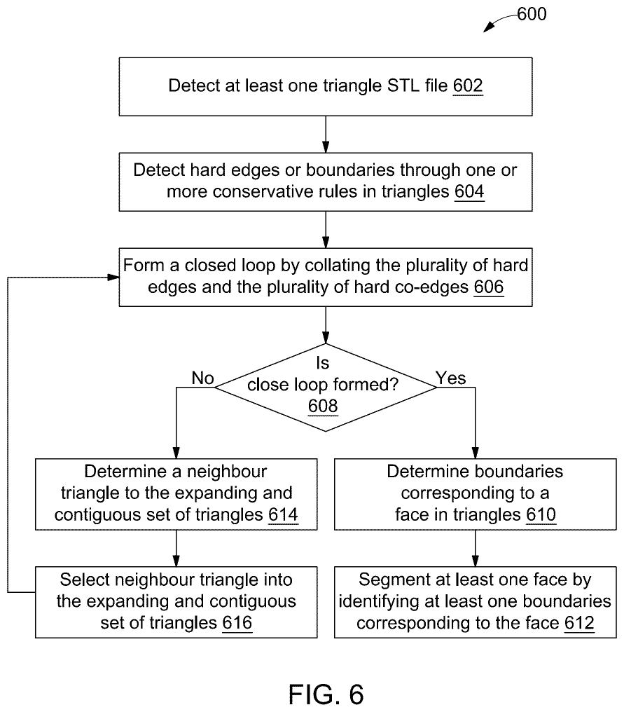

FIG. 6 illustrates a flowchart 600 of a method for segmenting one or more faces in an STL file generated from a user device, in accordance with an exemplary embodiment of the present disclosure. At step 602, at least one triangle may be detected by the computing device 102 in the STL file. The STL file may be generated from a non-parametric CAD application, and hence, each facet of the component may include a plurality of triangles, which may be detected by the computing device 102 using the triangle detection module 202.

At step 604, at least one hard edges or hard co-edges of the plurality of triangles from the STL file may be detected by the computing device 102. Particularly, the computing device 102 with the edge determination module 204, may be configured to determine at least one hard edges or hard co-edges based on a predefined rule, or a machine learning model. At step 606, a closed loop may be determined by the computing device 102, based on collating at least one hard edges or hard co-edges. The computing device 102, with the loop determination module 206, may be configured to determine the one or more loops formed by collating the hard edges, or hard co-edges. At step 608, the computing device 102 may be configured to determine if the closed loops are formed or not.

If the closed loops are formed, the method may proceed to step 610, in which the computing device 102 using the boundary determination module 206, may be configured to identify boundaries associated with the closed loops formed by the hard edges or the or hard co-edges of one or more triangles. Further, based on the boundaries identified, the method may proceed to step 612, in which at least one face may be identified the computing device 102, using the face segmentation module 208. The method is already explained in detail in conjunction with FIGS. 1-3.

If the closed loops are not formed, the method may proceed to step 614, in which an additional triangle, or a neighbor triangle in the contiguous and expanding set of triangles may be identified by the computing device 104, using the triangle detection module 202. Further, at step 616, the computing device 102 may be configured to select and include the additional triangle in the one or more triangles detected at step 602. Further, the method may proceed to step 606, and may be iterated until a loop is formed when the hard edges and the co-edges are formed after the additional triangle may be included in the one or more triangles.

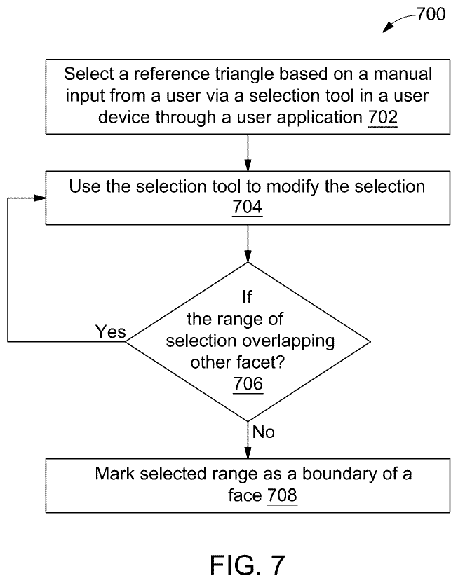

Referring now to FIG. 7, illustrates a flowchart 700 of a method for visual inspection and correction of a segmented face of a component in a Stereolithography (STL) file, in accordance with an exemplary embodiment of the present disclosure. At step 702, a reference triangle may be determined, and selected based on an manual user input via a selection tool in a user device through a user application, or an user interface 110. Further, at step 704, the range of selection may be modified by the computing device, based on user inputs received upon operating the selection tool. At step 706, the computing device 102 may be configured to determine if the range of selection overlaps an adjacent facet. If not, the method may proceed to step 708, in which the range of selection is marked as a boundary of the face by the computing device 102. If the range of selection is overlapping an adjacent facet, the method may proceed to step 704, and may be iterated until the range of selection may not overlap the adjacent facet.

Various embodiments provide method and system for simultaneously testing multiple Device Under Test (DUT) blocks. The disclosed method and system may initiate a schema-less dashboard canvas through a frontend application that invokes a server-less library. The server-less library may include a plurality of native widgets and a plurality of adaptors corresponding to a plurality of third-party widgets. The plurality of third-party widgets may be based on one or more different user interface (UI) technologies and one or more different data schemas. Further, the disclosed method and system may integrate a set of widgets selected by a user, from the plurality of native widgets and from the plurality of third-party widgets, with the schema-less dashboard canvas using the server-less library. The one or more of the selected third-party widgets from the set of widgets may be integrated using one or more corresponding adaptors. Further, each of the set of widgets may be independently configurable by the user to generate the customized dashboard. Moreover, the disclosed method and system may generate metadata for each of the set of widgets based on a corresponding configuration performed by the user. The metadata may include a set of unique widget properties. Thereafter, the disclosed method and system may associate the metadata with a user account of the user for subsequent selecting of the customized dashboard for the user.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Although the present invention has been described in connection with some embodiments, it is not intended to be limited to the specific form set forth herein. Rather, the scope of the present invention is limited only by the claims. Additionally, although a feature may appear to be described in connection with particular embodiments, one skilled in the art would recognize that various features of the described embodiments may be combined in accordance with the invention.

Furthermore, although individually listed, a plurality of means, elements or process steps may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather the feature may be equally applicable to other claim categories, as appropriate.

What is claimed is:

1. A method for segmenting at least one face of a component in a Stereolithography (STL) file, the method comprising:
detecting, by a controller, an expanding and contiguous set of triangles based on an order of occurrence thereof in the STL file;
identifying, by the controller, a plurality of hard edges and a plurality of hard co-edges of each triangle from the expanding and contiguous set of triangles;
determining, by the controller, a closed loop formed by collating the plurality of hard edges and the plurality of hard co-edges, wherein the closed loop forms a boundary corresponding to a face; and
segmenting, by the controller, at least one face by identifying at least one boundaries corresponding to the face based on the determining the closed loop.

2. The method of claim 1, further comprising:
when the closed loop is not formed by the plurality of hard edges and the plurality of hard co-edges,
determining, by the controller, a neighboring triangle to the expanding and contiguous set of triangles; and
including, by the controller, the neighboring triangle into the expanding and contiguous set of triangles.

3. The method of claim 1, wherein detecting the expanding and contiguous set of triangles further comprises:
identifying, by the controller, an edge as the plurality of hard edges or the plurality of hard co-edges based on a predefined rule, the predefined rule comprising:
an edge angle subtended by at least two triangles adjoined about the edge exceeding a predefined angle threshold.

4. The method of claim 1, wherein detecting the expanding and contiguous set of triangles further comprises:
identifying, by the controller, the plurality of hard edges and the plurality of hard co-edges based on a machine learning model.

5. A method for visual inspection and correction of a segmented face of a component in a Stereolithography (STL) file, the method comprising:
determining, by a controller, a reference triangle based on a manual input from a user via a selection tool embedded in a user interface accessible to the user through a user device; and
determining, by the controller, a face of the component by selecting one or more successive triangles occurring contiguously in a neighborhood of the reference triangle in an order of occurrence of an expanding and contiguous set of triangles in the STL file,
wherein the one or more successive triangles are selected based on a range of selection manipulated by the user using the selection tool.

6. The method of claim 5, wherein the range of selection of one or more triangle is displayed on the user device, wherein the range of selection is manipulated by the user through the user interface based on a visual inspection of the range of selection.

7. A system for segmenting at least one face of a component in a stereolithography (STL) file, the system comprising:
a processor; and
a memory communicatively coupled to the processor, wherein the memory is configured to store processor-executable instructions, which when executed by the processor causes the processor to:
detect an expanding and contiguous set of triangles based on an order of occurrence thereof in the STL file;
identify a plurality of hard edges and a plurality of hard co-edges of each triangle from the expanding and contiguous set of triangles;
determine a closed loop formed by collating the plurality of hard edges and the plurality of hard co-edges, wherein the closed loop forms a boundary corresponding to a face; and
segment at least one face by identifying at least one boundaries based on the determination of the closed loop.

8. The system of claim 7, wherein, if the closed loop are not formed by the plurality of hard edges and the plurality of hard co-edges the processor-executable instructions further causes the processor to:
determine a neighboring triangle to the expanding and contiguous set of triangles; and
include the neighboring triangle into the expanding and contiguous set of triangles.

9. The system of claim 7, wherein to determine the expanding and contiguous set of triangles, the processor-executable instructions further causes the processor to:
identify an edge as the plurality of hard edges or the plurality of hard co-edges based on a predefined rule, the predefined rule comprising:
an edge angle subtended by at least two triangles adjoined about the edge exceeding a predefined angle threshold.

10. The system of claim 9, wherein the processor-executable instructions further causes the processor to:
identify the plurality of hard edges and the plurality of hard co-edges based on a machine learning model.

11. A system for visual inspection and correction of a selection of a segmented face of a component in a Stereolithography (STL) file, the system comprising:
a user device comprising a processor, and a memory communicatively coupled to the processor, wherein the memory is configured to store processor-executable instructions, which when executed by the processor causes the processor to:
determine a reference triangle based on a manual input from a user via a selection tool embedded in a user interface accessible to the user through the user device; and
determine a face of the component by selecting one or more successive triangles occurring contiguously in a neighborhood of the reference triangle in an order of occurrence of an expanding and contiguous set of triangles in the STL file, wherein the one or more successive triangles are selected based on a range of selection manipulated by the user using the selection tool.

12. The system of claim 11, wherein the range of selection of one or more triangle is displayed on the user device, wherein the range of selection is manipulated by the user through the user interface based on a visual inspection of the selection.

13. A non-transitory computer-readable medium storing a set of computer-executable instructions of segmenting one or more faces of a component in a stereolithography (STL) file, the set of computer-executable instructions configured for:
detecting, an expanding and contiguous set of triangles based on an order of occurrence thereof in the STL file;
identifying, a plurality of hard edges and a plurality of hard co-edges of each triangle from the expanding and contiguous set of triangles;
determining, a closed loop formed by collating the plurality of hard edges and the plurality of hard co-edges, wherein the closed loop forms a boundary corresponding to a face; and
segmenting, at least one face by identifying at least one boundaries corresponding to the face based on the determining the closed loop.

14. The non-transitory computer-readable medium of claim 13, wherein, if the closed loop are not formed by the plurality of hard edges and the plurality of hard co-edges, the set of computer-executable instructions are further configured for:
determining, a neighboring triangle to the expanding and contiguous set of triangles; and
selecting, the neighboring triangle into the expanding and contiguous set of triangles.

15. The non-transitory computer-readable medium of claim 13, wherein for detecting the expanding and contiguous set of triangles, the set of computer-executable instructions are further configured for:
identifying an edge as the plurality of hard edges and the plurality of hard co-edges based on a predefined rule, the predefined rule comprising:
an edge angle subtended by at least two triangles adjoined about the edge exceeding a predefined angle threshold.

16. The non-transitory computer-readable medium of claim 15, wherein the set of computer-executable instructions are further configured for:
identifying the plurality of hard edges and the plurality of hard co-edges based on a machine learning model.
